(19) United States
(12) Patent Application Publication
(10) Pub. No.: US 2015/0152782 A1
(43) Pub. Date: Jun. 4, 2015

(54) ROTARY PISTON HEAT ENGINE

(71) Applicant: Francisco Javier RUIZ MARTINEZ, Palmanyola - Baleares (ES)

(72) Inventor: Francisco Javier Ruiz Martinez, Baleares (ES)

(21) Appl. No.: 14/415,494

(22) PCT Filed: Jun. 24, 2013
(86) PCT No.: PCT/ES2013/070411

§ 371 Date: Jan. 16, 2015

(30) Foreign Application Priority Data
Jul. 16, 2012 (ES) P201231113

(51) Int. Cl. F02B 53/02

(52) U.S. Cl. CPC F02B 53/02

(57) ABSTRACT

A rotary piston heat engine consisting of a mechanism based on a lever anchored to the periphery of a crankcase formed by two shells coupled to one another, by means of a shaft (3) located at one of the ends thereof, which enables it to pivot on the same, with an intermediate grooved portion, along which the rod of a crankshaft slides and which, with the other end, acts on a piston coupled by means of a connecting rod. The rotation of the crankcase (1) on the crankshaft (8) induces the displacement of the piston (5) coupled to the lever (2) by means of the connecting rod (4) inside the cylinder (6), the gas being compressed inside this chamber and initiating the cycle of an internal combustion engine. The shaft of the crankshaft may be blocked, thus impeding its rotation, or coupled to a single direction clutch. The basic assembly of this engine is formed by a block of two cylinders coupled to the crankcase and a crankshaft of two rods located at 180°, which act on two symmetrical levers that move both pistons.

### BACKGROUND OF THE INVENTION

1. Field of the Invention

The present invention falls within the general field of industry and more specifically, within the transport sector.

2. Description of the Related Art

Heat engines are generally well known and as such, reference shall not be made to them. Although several proposals for developing rotary tangential piston engines exist, they have not been materialised to date, owing to their inefficient design resulting from the fact that they are based on the actuation of a lever structured on two arms, one of which is grooved, along which the crankshaft rod slides and which, upon pivoting on the intermediate shaft, produces a linear movement in a piston coupled by means of a connecting rod at the end of the other arm. This arrangement does not facilitate the rotation of the block and may only act on the crankshaft with a very low output. Patents ES2072175 and ES 2 261 007.

### SUMMARY OF THE INVENTION

The present invention relates to a rotary engine that is in some ways in-keeping with the design type cited above, however with a completely different structure that modifies the actuation of the assembly. Operation is based on a lever anchored to the periphery of a crankcase by means of a shaft at one of the ends thereof, which enables it to pivot on the same, with an intermediate grooved portion, along which the crankshaft rod slides, the piston being coupled at the other end by means of a connecting rod. This new structure makes it possible for the block to rotate on the shaft of the crankshaft when a force is applied to the cylinder head, the rod acting as a support point and the shaft of the lever as a resistance point. The crankshaft may be fixed to the structure, or may rotate in the opposite direction, actuated by the force exerted by the piston, which is transmitted to the rod by means of the connecting rod and the lever, in this case in order to prevent one element from dragging the other during the start of the movement, both shafts, pertaining to both the crankshaft and the block, being coupled individually to both single direction clutches, which determine that the rotation of both is produced in the opposite direction. The term “assembly” employed herein refers to a block made up of two cylinders and a crankshaft, with two rods located at 180° (various assemblies may be coupled to one another) actuated by two equally opposite levers, this arrangement facilitating a perfect balance of the assembly, both dynamically and aesthetically.

This new design contributes a series of clear advantages, which have not yet been sufficiently proven:

a considerable increase in heat efficiency, a reduction in weight for the same power and less friction when the piston slides;

fewer elements are required, upon the invention being able to cool itself using air, thus reducing the cost of each unit considerably;

not only is the length of the piston stroke determined by the diameter of the crankshaft, but also by the structure and length of the lever, thus improving the engine dimensions.

### BRIEF DESCRIPTION OF THE DRAWINGS

In order to complement the present description, with the aim of facilitating a better understanding of the characteristics of the present invention, this specification is accompanied by a set of drawings, which form an intrinsic part thereof, wherein the following is represented by way of non-limiting illustration:

FIG. 1.—Is a plan view of a shell with the couplings of the internal elements, as well as of the cylinders and cylinder heads, also showing one of the possible locations of the valves for 2 and 4-stroke operation.

FIGS. 2 and 3.—Show the displacement of the pistons when the block is rotated on the crankshaft.

FIG. 4.—Shows the position of the oil recovery pumps as well as a potential location of the gears for actuating the admission and exhaust valves for a 4-stroke engine.

FIG. 5.—Shows some of the advantages of this arrangement: the 76 mm diameter of the crankshaft and the piston developing a piston stroke of 111 mm, it also being possible to observe that the linear time difference of the connecting rod in its course is 6 mm, thus meaning that the side loads on the pistons are minimal.

FIG. 6.—Shows a cross-section with the arrangement in the shells of the levers and the crankshaft.

FIG. 7.—Shows the schematic anchoring of the shafts of the block and of the crankshaft by means single direction clutches.

FIG. 8.—Is an exploded view of an example of engaging the shafts of the crankcase and of the crankshaft to a common output shaft.

The shape, size and arrangement of the elements may be varied, provided that this does not constitute a modification of the essence of the invention.

The terms in which this specification is written must always be understood in an ample, non-limiting sense.

### DETAILED DESCRIPTION OF THE EMBODIMENTS OF THE INVENTION

This rotary piston heat engine is made up of a basic assembly formed by two shells coupled to one another, which contain the crankshaft and the levers that actuate the pistons and where the cylinders and the rest of the mechanisms needed for the engine to be able to function are coupled.

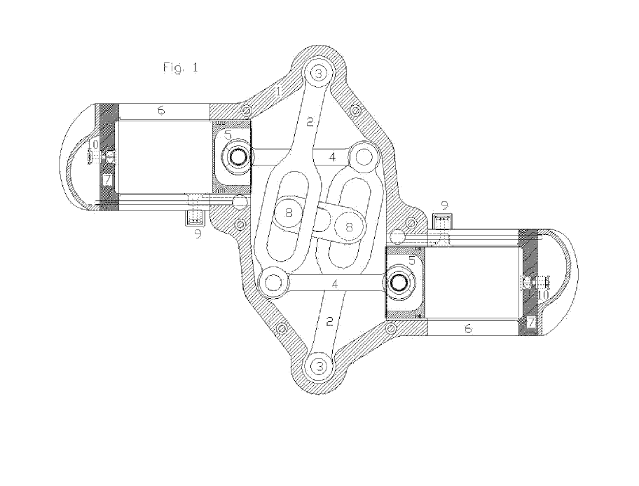

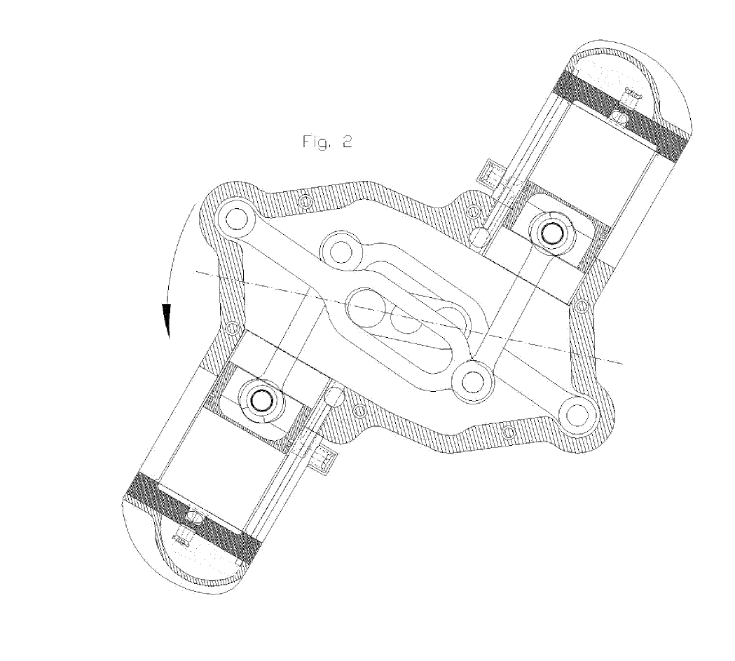

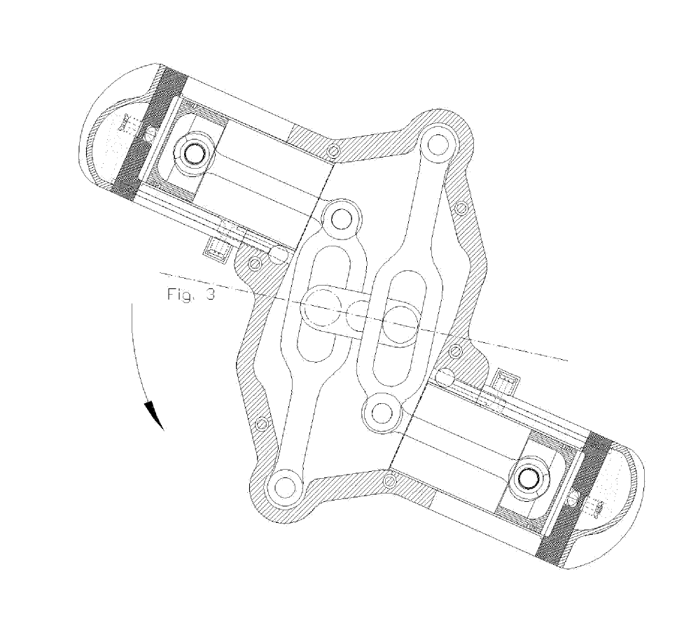

In FIG. 1, which is a plan view, it is possible to observe the shell (1) where the levers (2) are coupled by means of their shafts (3), the connecting rods (4) that actuate the pistons (5) being connected at the other side, the same being displaced along the cylinders (6) where the cylinder heads (7) are coupled. The crankshaft is located at the centre of the shell with its rods (8), each one of which slides along the central groove of the corresponding lever and which drag the pistons when the block rotates. FIGS. 2 and 3 show the course of the pistons upon the assembly rotating and the crankshaft remaining in the same position as before.

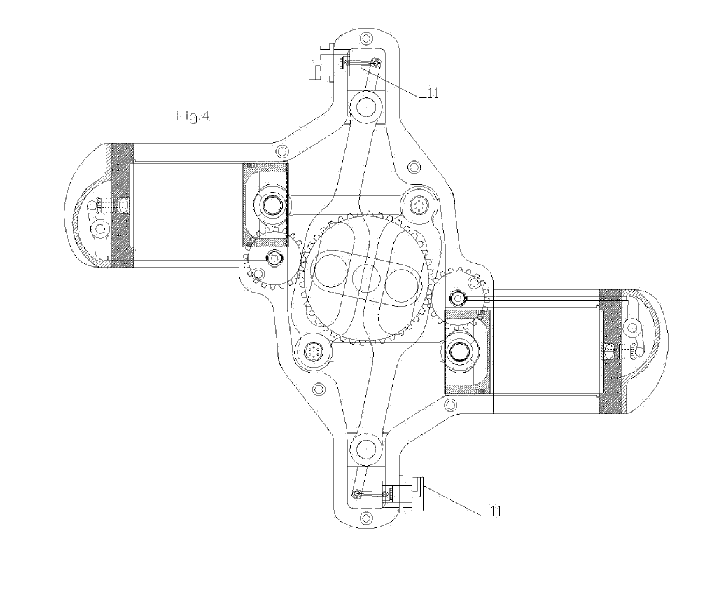

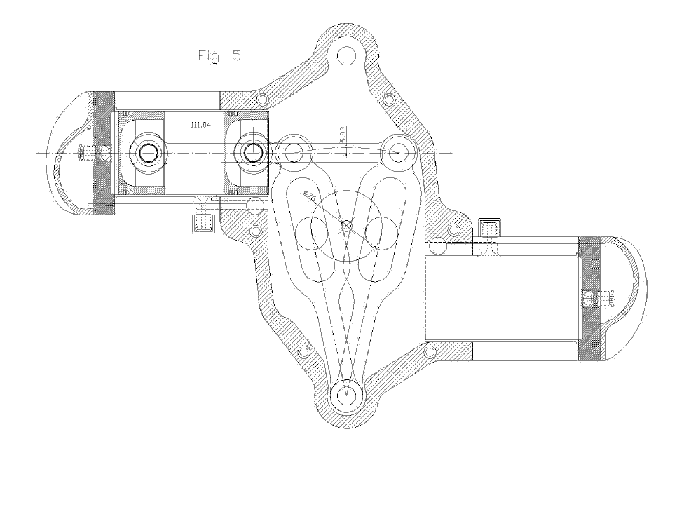

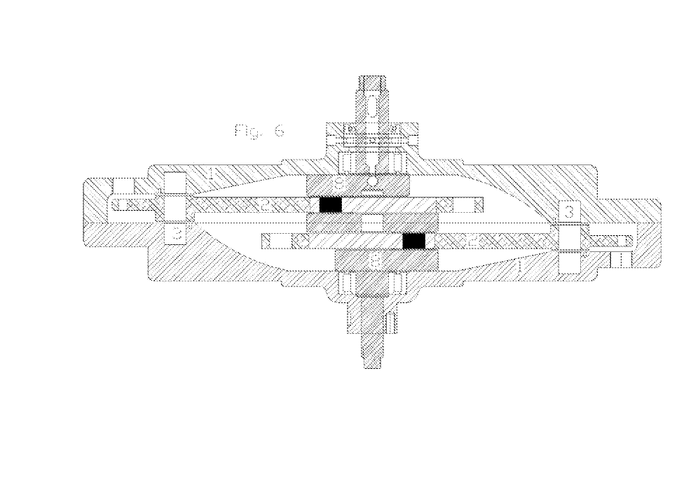

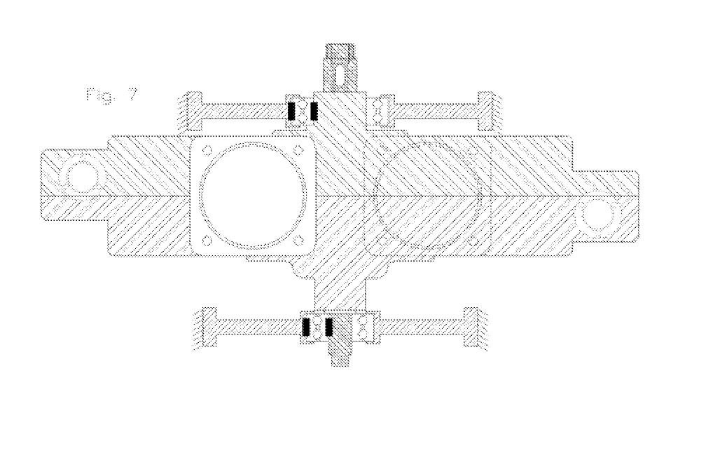

This engine design may operate in 2-stroke or 4-stroke. In 2-stroke, it may operate in two different modes: one standard mode with nozzles, and another mode with two guided valves, as shown in FIG. 1, the “admission” valve (9) linking the crankcase to the cylinder at the appropriate moment and the exhaust vale (10), which is equally controlled, enabling gases to escape at the appropriate moment. These valves may be actuated by the crankshaft by means of gears, pulleys or other means or may be controlled electromagnetically. In this case, the air/fuel mixture would be input via the front shaft of the crankshaft and in both cases, an ignition system should be incorporated. In order for the same to operate in 4-stroke, the fuel would be supplied via the shaft and the oxidizer would be taken directly from the cylinder head and may operate with both petrol and other fuels. A grease system is proposed for this case, with the lubricant deposit being located outside, the same being incorporated and recovered via the front shaft by means of a rotary joint, driving it with a pump and likewise recovering it with two pumps (11) actuated by the levers (FIG. 4).

In order to present the operation mode, operation is shown as a 2-stroke engine and, in order to make this more clear, it is proposed that the crankshaft remains static, thus, starting with FIG. 1 which corresponds to the end of the explosion cycle, the gasses have already exited to the outside through the exhaust valve in the cylinder head (10) and the air/fuel/oil mixture, which is compressed inside the crankcase, enters through the admission valve (9) which opens, linking the crankcase to the inside of the cylinder and closes when the piston begins its upwards piston stroke. The mixture is compressed (FIG. 2) and when it reaches maximum compression (FIG. 3) the explosion is produced, the gasses acting on the cylinder head giving rise to the rotation of the same, upon being supported on the crankshaft rod, the force being exerted on the shaft of the lever.

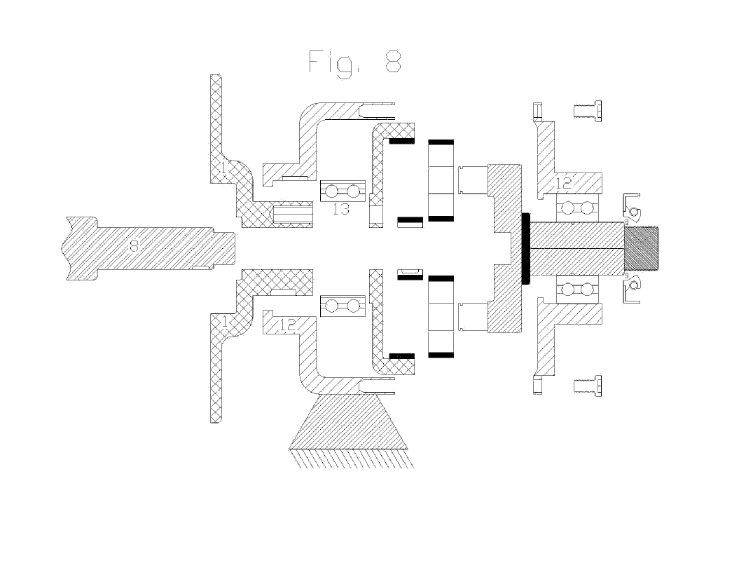

In the event of the crankshaft getting blocked, the energy generated is transmitted to an output shaft coupled directly to the crankcase of the assembly and, in the event of the rotation of both being proposed, the shafts are coupled by means of gears (FIG. 8). The crankcase is joined to a crown contained in a toothed shell and the shaft of the crankshaft passes through its centre, the same being coupled to the internal gear, two pinions being engaged between both, placed at 180°, which are coupled to the power output shaft, the rotation of both the crankcase and the crankshaft therefore dragging the power output shaft.

1. A rotary piston heat engine, made up of a block formed by two shells coupled to one another, which contain a crankshaft with two rods and two levers, where the cylinders and the rest of the mechanisms needed in order for the engine to function are coupled, characterised in that each lever (2) that pivots on a shaft (3) located on one of the ends thereof and anchored to the periphery of the shells contains an intermediate groove, where the crankshaft rod (8) slides and which has a piston (5) coupled to the other end by means of a connecting rod (4), this arrangement making the block, with all the elements, rotate on the crankshaft, induced by the force exerted in the expansion of a gas between the cylinder head (7) and the piston, upon being supported on the crankshaft rod, meanwhile also provoking the rotation of the crankshaft.

2. The rotary piston heat engine according to claim 1, characterised in that the position of the levers is symmetrical and each one is actuated by the crankshaft rod of two rods located at 180°.

3. The rotary piston heat engine according to claim 2, characterised in that the crankshaft is blocked and only the rotation of the block is allowed.

4. The rotary piston heat engine according to claim 3, characterised in that the block and the crankshaft are coupled individually to a single direction clutch, which facilitates the rotation of both, but in the opposite direction.

5. The rotary piston heat engine according to claim 4, characterised in that it operates in 2-stroke cycles, either by means of nozzles or with controlled valves.

6. The rotary piston heat engine according to claim 4, characterised in that it operates in 4-stroke cycles.

7. The rotary piston heat engine according to claim 6, characterised in that it is made up of two or more blocks of two cylinders.

8. A rotary piston heat engine, having a block formed by two shells coupled to one another, which contain a crankshaft with two rods and two levers, further including cylinders and mechanisms needed in order for the engine to function are coupled, comprising at least one, in that each lever (2) that pivots on a shaft (3) located on one of the ends thereof and anchored to the periphery of the shells having an intermediate groove, where a crankshaft rod (8) slides and having a piston (5) coupled to the other end by means of a connecting rod (4), this arrangement defining a block, that rotates, rotate on the crankshaft, induced by the force exerted in the expansion of a gas between the cylinder head (7) and the piston, upon being supported on the crankshaft rod, thereby provoking the rotation of the crankshaft.

9. The rotary piston heat engine according to claim 8, characterised in that the position of the levers is symmetrical and each one is actuated by the crankshaft rod of two rods located at 180°.

10. The rotary piston heat engine according to claim 9, characterised in that the crankshaft is blocked and only the rotation of the block is allowed.

11. The rotary piston heat engine according to claim 10, characterised in that the block and the crankshaft are coupled individually to a single direction clutch, which facilitates the rotation of both, but in the opposite direction.

12. The rotary piston heat engine according to claim 11, characterised in that it operates in 2-stroke cycles, either by means of nozzles or with controlled valves.

13. The rotary piston heat engine according to claim 12, characterised in that it operates in 4-stroke cycles.

14. The rotary piston heat engine according to claim 13, characterised in that it is made up of two or more blocks of two cylinders.
